(19) United States
(12) Patent Application Publication
(10) Pub. No.: US 2001/0046654 A1
(43) Pub. Date: Nov. 29, 2001

(54) System and method for whitening teeth

(76) Inventors: Peter D. Zavitsanos, Gwynedd Valley, PA (US); Robert J. Downs JR., Gwynedd Valley, PA (US)

Correspondence Address: Klehr, Harrison, Harvey, Branzburg, & Ellers, 260 South Broad Street, Philadelphia, PA, 19102, US

(21) Appl. No.: 09/815,501

(22) Filed: Mar. 23, 2001

Related U.S. Application Data
(60) Provisional application No. 60/192,213, filed on Mar. 27, 2000.

(51) Int. Cl. A61C 3/00; A61C 5/00

(52) U.S. Cl. 433/32; 433/215

(57) ABSTRACT

A teeth whitening system includes a heating module, a mouthpiece thermally connected to the heating module such that heat can be transferred to the mouthpiece, and a heat-activated whitening gel positioned in the mouthpiece such that the gel contacts a user's teeth, whereby when heat is transferred from the heating module to the mouthpiece, the gel is activated and whitens the user's teeth.

### CROSS REFERENCE TO RELATED APPLICATIONS

This is a § 111 (a) application relating to U.S. application Ser. No. 60/192,213 filed Mar. 27, 2000.

### FIELD OF THE INVENTION

The present invention relates to a system and method for whitening teeth, and, more particularly, to a system and method employing the use of heat to accelerate the action of a bleaching medium.

### BACKGROUND OF THE INVENTION

Whiter teeth are desired for cosmetic reasons, and several processes to accomplish this have been described in the prior art. These processes have always included the use of bleaching gels or solutions containing various concentrations of hydrogen peroxide (H₂O₂) or carbamide peroxide (CH₆N₂O₃), which on an equal molar basis contains 35% H₂O₂ (by weight) which is released from activation by water or other sources such as heat or light. The degree of whitening provided by these processes increases with (a) peroxide concentration, (b) time of contact between the reacting species of peroxide and the tooth enamel surface, (c) diffusion rate into the dentine layer, (d) a favorable structure (texture) of tooth surface, and most importantly, (e) the rate of activation of the gel in terms of generating available peroxide (H₂O₂) and/or its reactive species (OH and O). Due to its chemical structure, the peroxide must produce transient species such as OH and O before the final products, H₂O and O₂, are generated by the following mechanism, 2 H₂O₂→4 OH→2H₂O+2O→2H₂O+O₂. The presence of these active transient species (radical OH and atomic oxygen O) play the most important role in the whitening process due to their higher reactivity. In other words, two peroxide molecules must break down to four OH molecules, which react to produce two water (H₂O) molecules and two atoms of oxygen. The final step is the recombination of atomic oxygen into molecular oxygen.

In most cases, tooth whitening is accomplished with custom fitted plastic trays filled with bleaching gels (known as “take home trays”) which are worn for one to several hours a day over an extended period of time such as several weeks or months before a satisfactory level of whitening is realized. Gel activation by light from laser sources or arc lamps in several regions of the electromagnetic spectrum, including infrared, visible, and ultraviolet, have been introduced with various and ambiguous levels of success due to: (a) lack of fundamental understanding of the mechanism involved in the whitening process, (b) lack of control in terms of the density of delivered energy, (c) the fraction of the energy absorbed by gel or absorbed by teeth, (d) shadowing effects, and (e) the necessity for prolonged periods of treatment if one tooth is treated at a time. (See, e.g., U.S. Pat. Nos. 4,952,143 and 4,661,070.)

Furthermore, some of the peroxide concentrations used (from 15% up to 30% H₂O₂) require effective gum isolation in order to prevent tissue burns. There is also a lack of information on the temperature that is generated by the light source and lack of temperature control. These factors can lead into gum burns and tooth sensitivity after the treatment and possible long-term effects that are presently unknown.

Another method, U.S. Pat. No. 4,983,381, involves the use of applying heat directly to the teeth with a thermocube or plate, which covers the teeth. This method is difficult to implement and requires soft tissue isolation and protection due to high concentrations of H₂O₂(30-70%) as well as requiring many steps and high temperatures (up to 55° C.). This design is also problematic because its close fit on the teeth does not allow enough volume for whitening gel. It also requires custom made plates (upper and lower arches) for each person.

Still another method, U.S. Pat. No. 5,927,981, utilizes a high temperature chamber for producing a high temperature (60° C.). In this method, a bleaching vapor is directed to the teeth. This process is difficult to implement and exposes the recipient to unnecessary safety risks due to both the tooth pulp and the gums (if not isolated) being exposed to high temperatures. In addition, its whitening effectiveness is uncertain and further complicated by the fact that the transient species O and OH may no longer be present in the “bleaching vapor” when it reaches the teeth.

The present invention provides a process which has the following advantages over the prior art: (a) lower peroxide concentrations (16% to 20% carbamide or 5 to 10% H₂O₂); (b) no gum isolation is required; (c) within one hour it can provide up to eleven shades of improvement, depending on age and level and type of coloration; (d) it provides greater comfort to recipient than take home trays or light activated whitening procedures; (e) it requires less peroxide over the course of the treatment than take home trays; and (f) it is safer than the light activation methods, especially those using high intensity lasers or other uncontrolled high intensity light sources, including those in the blue portion of the spectrum.

It should also be pointed out that this invention will accelerate the whitening process when the gel is confined by dentist-made take home trays or current office bleaching procedures which employ higher concentrations of hydrogen peroxide (30%) with isolation.

### SUMMARY OF THE INVENTION

The present invention provides a safe and effective way for whitening teeth through a combination of new techniques, including a balanced and controlled delivery of a bleaching medium. The present invention accelerates the action of the bleaching medium by raising (a) the gel temperature; (b) the concentration of active peroxide species of the gel at the interface between the tooth surface and the attached gel; and (c) the reaction rate between the active transient species (OH and O) of the peroxide and the coloring compounds in the teeth. A heating wave is provided by an accurately controlled thermal source which allows the temperature of the gel to reach a safe temperature range of 40°-42° C. The heating is also controlled by a combination of state of the art devices which control the temperature to ±1° C.

The device includes a heating element embedded into an aluminum (or other metal or material) cylinder referred to as a “heat sink” which is thermally insulated from the atmosphere with a plastic coating, highly insulating styrofoam composite, or other insulator. The temperature of the heat sink is controlled and maintained at a level of 45°-65° C. so that controlled thermal energy flows into a mouthpiece made from a metal matrix composite or other material which is thermally conductive due to its composition, including a metallic structure and plastic/organic filler or coating. The heat sink temperature is controlled so that the temperature of the mouthpiece and the gel does not exceed a preset level (about 41° C.±1°). In case this temperature is exceeded, a safety thermocouple at the base of the mouthpiece automatically shuts off the power of the control box. For added safety, the heating element is electrically insulated from its case by ceramic cement and the case is also insulated from the heat sink by another layer of cement. The exteriors of heat sink and the mouthpiece are further insulated by plastic or plastic styrofoam coatings, thus providing a third level of safety. In addition, the current demand (of the 30 watt heater at 120V) is low and is limited to 0.25 amperes.

The increased effectiveness and speed of the whitening process is due to the faster generation and mobility of H₂O₂ in the peroxide gel, the decomposition of H₂O₂ to OH and O, as well as the enhancement of the reaction rate between the active peroxide species (which can be radicals of OH or atomic oxygen O) and the compounds on the enamel and dentine responsible for the stains and coloration. It is the change in the molecular state and bond structure (from double to single carbon bonds) of the coloring compounds which accounts for the lighter color, as well as the removal of stain compounds from the enamel surface.

In addition to providing the heating by electrical means, other heating mechanisms are also effective. These include, but are not limited to: (a) immersing the heat sink in warm water, (b) heating the mouthpiece by warm water through a hollow construction of an appendix heat sink manually or with a pump, (c) making the heat sink out of a porous ceramic (or plastic) filled with water and heating in a microwave oven, and (d) preheating a hermetically sealed mouthpiece with gel in hot water or in a microwave oven. Because they are not electrically powered and controlled, these options may be less effective in that they may require multiple heating charges during the whitening procedure due to limited thermal retention. However, they do provide useful alternatives that may be safely used by consumers in their homes, as opposed to use by dental professionals in their offices. The alternative designs of these devices provide the advantage of heat-activated teeth whitening without the need for an electrically powered device. These alternative home units also provide the advantages of a one hour (or slightly more) procedure for whitening all teeth with a single mouthpiece and no tissue isolation.

The mouthpiece of the present invention is designed so that it will treat upper or lower teeth separately or both sets simultaneously. This invention provides redundant controls in several ways in order to ensure the safety of the patient from (a) higher temperatures than those which are physiologically experienced by the body such as fever or after drinking coffee or eating hot soup, which brings the tooth temperature up to 43° C., without any discomfort or harm to the teeth, and (b) electric shock from the heating element. The temperature is monitored and controlled by two thermocouples at two different positions; one monitors the temperature at the front of the mouthpiece and shuts off the power if the temperature exceeds the safety zone (even by one degree) and the other monitors the temperature at the heat sink and shuts off the power when the preset temperature is exceeded. The heating element is electrically isolated from the heat sink by two layers of ceramic cement insulation: one between the electrically heated element and the metal exterior of the cartridge heater, and another between the exterior of the cartridge heater and the heat sink. The conductive part of the mouthpiece, as well as the exterior or the heat sink are also insulated from direct contact with the human flesh or teeth.

The mouthpiece of the present invention is made of a metal matrix composite consisting of a high conductivity, high heat-capacity metal skeleton (e.g., aluminum, copper, steel or other conductive alloy) that is surrounded by or impregnated with a flexible foam or plastic material. One important feature of this invention is based on the heat wave delivery from the heat sink, which is kept in the range of 40° C.-70° C. (depending on the relative size of heat sink to mouthpiece), to the metal matrix composite and is designed so that the foam temperature does not exceed levels of comfort or safety, which is in the vicinity of 41° C.

The method of the present invention controls the flow of thermal energy from a heat sink in order to provide thermal activation of bleaching gels. It accelerates the reaction of peroxide active species with pathological and normal colorations thus resulting in a faster whitening process via controlled heat flow. The advantages of the proposed methods are as follows: (a) temperature control at the base of the mouthpiece ensures safety by protection from overheating higher than 41° C., which is an acceptable safe level; (b) the heating element is electrically isolated from the exterior of the heating unit module and the exterior of the cartridge heater is electrically isolated from the heat sink; (c) the conductive portion of the mouthpiece is isolated from the flesh of the mouth and the teeth; (d) it allows use of gels with lower peroxide concentrations which do not require protection and/or isolation of the gums through the application of coatings; (e) it works with a variety of hydrogen peroxide and/or carbamide peroxide gels; (f) it provides a reservoir of peroxide sufficient to last at least a 30-minute treatment, to be repeated two or three times with new gel for best results; and (g) the energy flow created by the heat sink as well as the construction of the mouthpiece provide the necessary balance required for the safety of the system. Items (a) and (b) provide safety and protection to the user by redundancy.

Other useful features of this invention include the fact that the metal component of the mouthpiece does not require plaster models to be made (to custom fit to the teeth) because it is large enough to fit most, if not all, mouth sizes due to the rigid front wall and the flexible foam or plastic back wall which provides the desirable fit around the teeth of any size or geometry. The construction of the mouthpiece is such that one mouthpiece can treat both upper and lower teeth simultaneously. The fact that the mouth is closed during treatment provides greater comfort to the recipient of the treatment, as compared to other methods based on light activation where the mouth is forced open with a lip retractor during the entire procedure. For several reasons (including safety and sanitary reasons), the metal matrix mouthpiece is designed to be disposable, such that it can be discarded at the end of the procedure. In the case of the home unit, the same metal mouthpiece can be used as many times as needed by the owner, especially for touch-up, every six months or so.

### BRIEF DESCRIPTION OF THE DRAWINGS

For a better understanding of the present invention, reference is made to the following detailed description of several exemplary embodiments considered in conjunction with the accompanying drawings, in which:

FIG. 1 is a block diagram of a preferred embodiment of a teeth whitening instrument constructed in accordance with the present invention;

FIG. 2 is a cross-sectional side view of a mouthpiece used in connection with the instrument shown in FIG. 1;

FIG. 3 is a top view, in partial cross-section, of an alternate embodiment of the connection between the mouthpiece and the heating module shown in FIG. 1;

FIG. 4 is a cross-sectional side view of a first alternate embodiment of a teeth whitening instrument constructed in accordance with the present invention; and

FIG. 5 is a cross-sectional side view of a second alternate embodiment of a teeth whitening instrument constructed in accordance with the present invention.

### DETAILED DESCRIPTION OF THE INVENTION

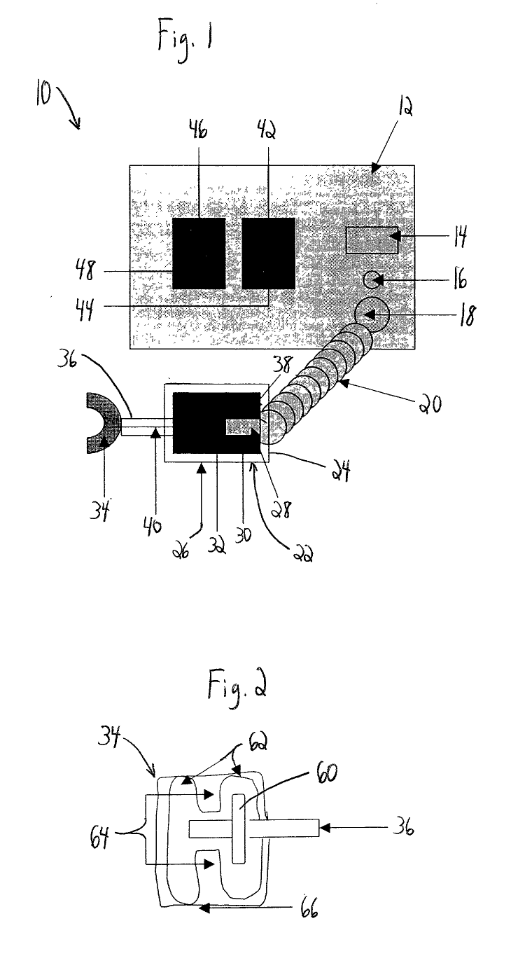

A teeth whitening device 10, as shown in FIG. 1, includes a control box 12, which houses a power source to operate the teeth whitening device 10. The control box 12 has a rectangular shape with sufficient room on the top or front side for several controls. An on/off switch 14 is located on the top of the control box 12 and is electrically connected to the power source. A replaceable fuse 16 is positioned inside the control box 12 and is electrically connected between the switch 14 and a connector 18. The connector 18 is used to connect a power cord 20 of a heating module 22 to the control box 12.

The heating module 22 consists of a case 24 having an outer layer 26 made of thermal insulation. A cartridge heater 28 is positioned inside the case 24 and is electrically connected to the power cord 20. A safety control 30 is electrically connected to the cartridge heater 28, in order to control the temperature of the cartridge heater 28. A heat sink 32 is electrically connected to the cartridge heater 28 such that the heat sink 32 retains heat generated by the cartridge heater 28. The heat sink 32 is a cylinder made of aluminum or other heat-conducting material which surrounds the heating element of the cartridge heater 28. The heat sink 32 is thermally insulated with an outer coating made of plastic, an insulating styrofoam composite, or other insulating material.

A mouthpiece 34 is attached to the heating module 22 via a connector 36 which also provides heat flow to the mouthpiece 34 from the heat sink 32. A thermocouple 38, mounted in the heat sink 32, and a thermocouple 40, located in the connector 36, act together to regulate the temperature of the mouthpiece 34. If the temperature of the heat sink 32 exceeds the preset temperature range, the thermocouple 38 shuts off the power source in the control box 12, thereby preventing the heat sink 32 from heating further. Similarly, if the temperature of the mouthpiece 34 exceeds its preset level, the thermocouple 40 shuts off the power source in the control box 12, thereby preventing the mouthpiece 34 from heating further.

In order to accurately control the temperature of the mouthpiece 34, a number of controls are provided on the control box 12. The temperature of the heat sink 32 is indicated on a temperature display 42 and is adjusted by a controller 44. The temperature of the mouthpiece 34 is shown on a temperature display 46 and is pre-configured to approximately 41° C. A safety control 48, operating in conjunction with the safety control 30 in the heating module 22, is used to maintain the temperature of the mouthpiece 34 within a tolerance of ±1° C., such that the temperature of the mouthpiece 34 is within a range of 40°-42° C.

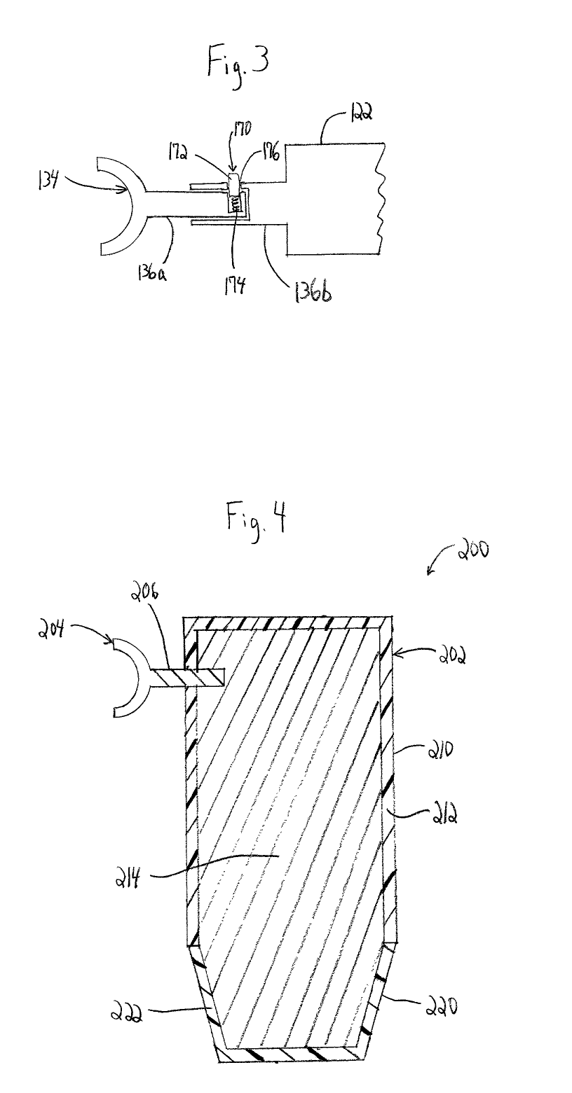

FIG. 2 shows details of the construction of the mouthpiece 34. The connector 36, which is removably attached at one end to the heat sink 32, is fixedly attached at an opposite end to a metallic substructure 60 that forms the “backbone” of the mouthpiece 34. The connector 36 may be force-fit or friction-fit into the heat sink 32, or may be removably connected to the heat sink 32 by any conventional means. Some illustrative examples of a removable connection between the connector 36 and the heat sink 32 will be described below in connection with FIG. 3. A tooth form 62, composed of molded foam or plastic, surrounds the metallic substructure 60 and is designed to transfer heat from the metallic substructure 60 to a user's teeth. The tooth form 62 can be constructed as fitting either the upper or lower teeth only, or as fitting both the upper and lower teeth simultaneously. When in use, a heat-activated gel 64 is placed in the tooth form 62, whereby the gel 64 coats the user's teeth. The mouthpiece 34 can be manufactured to already include the gel 64 in the tooth form 62; in such circumstances, a seal 66 is provided around the tooth form 62 to retain the gel 64 therein and to preserve the sterility of the mouthpiece 34.

The following discussion of the operation of the present invention assumes that the mouthpiece 34 is attached to the cartridge heater 28 and the seal 66, if present, has been removed. First, the user inserts the mouthpiece 34 into his or her mouth, with the tooth form 62 surrounding the teeth, permitting the gel 64 to coat the teeth. The user then moves the switch 14 to the “on” position, which begins heating the heat sink 32 to a temperature of between 75°-80° C. The heat is transferred from the heat sink 32 to the metallic substructure 60, such that the tooth form 62 is heated to a temperature of approximately 41° C. The safe temperature range for both the activation of the gel 64 and the safety of the user's teeth and gums is between 40°-42° C. At higher temperatures, there is a risk of burning the user's gums. While the mouthpiece 34 is in position, the user can place the case 24 on his or her chest (or through a brace), so that the user does not have to hold the case 24 during the entire length of the procedure. Another arrangement is to position the mouthpiece perpendicular to the heat sink (i.e., attached to the side).

The gel 64 is of a type that has a low peroxide concentration (e.g., 16%-20% carbamide or 5.6%-10% H₂O₂). Using a gel 64 having high viscosity and low peroxide concentration avoids having to isolate the user's gums to prevent burns. The combination of the gel 64, the temperature of the mouthpiece 34, and the time the mouthpiece 34 is worn (approximately a total of one hour in 20 or 30-minute segments with gel replacement), can provide up to eleven shades of whitening. The increased effectiveness and speed of the whitening process is due to the faster generation and mobility of H₂O₂ in the peroxide gel 64 as well as the enhancement of the reaction rate between the active peroxide species (which can be radicals of OH and atomic oxygen O) and the compounds on the enamel and dentine responsible for the stains and coloration. It is the change in the molecular state and bond structure (from double to single carbon bonds) of the coloring compounds in dentine which accounts for the lighter color as well as the removal of staining substance from the enamel surface.

The present invention provides redundant controls in several ways in order to prevent exposing the patient to higher temperatures than those which are physiologically experienced by the body (such as fever), and to reduce the possibility of electric shock from the heating element. The temperature of the mouthpiece 34 is monitored and controlled by the two thermocouples 38, 40, which are located in two different positions. The thermocouple 38 monitors the temperature at the heat sink 32 and shuts off the power when the preset temperature is exceeded and the thermocouple 40 monitors the temperature at the front of the mouthpiece 34 and shuts off the power if the temperature exceeds the safety zone, even by one degree. The heating element of the cartridge heater 28 is electrically isolated from the heat sink 32 by two layers of insulation, preferably made of ceramic cement: one between the electrically heated element and the exterior of the cartridge heater 28, and another between the exterior of the cartridge heater 28 and the heat sink 32. The metallic substructure 60 of the mouthpiece 34 is also insulated from direct contact with the human flesh or teeth.

The advantages of the teeth whitening device 10 include: (a) the thermocouple 40 in the connector 36 to the mouthpiece 34 helps to prevent overheating the mouthpiece 34 higher than the preferred 41° C. level; (b) the heating element of the cartridge heater 28 is electrically isolated from the exterior of the case 24 and the exterior of the cartridge heater 28 is electrically isolated from the heat sink 32; (c) the metallic substructure 60 of the mouthpiece 34 is isolated from the flesh of the mouth and the teeth; (d) the use of a variety of gels 64 with low peroxide concentrations, which do not require protection and/or isolation of the gums through the application of coatings; (e) providing a reservoir of gel 64 sufficient to last throughout the process (approximately one hour) without re-application of gel; and (f) the energy flow created by the heat sink 32, as well as the construction of the mouthpiece 34, provide safety balance.

Another exemplary embodiment of a mouthpiece constructed in accordance with the present invention is illustrated in FIG. 3. Elements illustrated in FIG. 3 which correspond to the elements described above with respect to FIGS. 1 and 2 have been designated by corresponding reference numerals increased by one hundred. The embodiment of FIG. 3 is designed for use in the same manner as the embodiment of FIGS. 1 and 2 unless otherwise stated.

Referring now to FIG. 3, an alternate configuration for locking the mouthpiece 134 to the heating module 122 is shown. The connector 136 has two portions: a first portion 136a fixedly attached to the mouthpiece 134 and a second portion 136b fixedly attached to the heating module 122. The first portion 136a and the second portion 136b are releasably connected via a locking mechanism 170. The locking mechanism includes a pin 172 biased by a spring 174, both of which are mounted in the first portion 136a opposite the mouthpiece 134. The pin 172 engages an opening 176 in the second portion 136b to lock the first portion 136a within the second portion 136b. To separate the first portion 136a from the second portion 136b, the user pushes on the pin 172 to pass it through the opening 176, which permits the first portion 136a to slide within and relative to the second portion 136b. Being able to separate the mouthpiece 134 from the heating module 122 allows the mouthpiece 134 to be easily cleaned or discarded.

In addition to the locking mechanism 170, the mouthpiece 134 may be connected to the heating module 122 by any other conventional means, such as, for example, inserting a set screw through the opening 176 so that it engages the first portion 136a or by threadedly connecting the mouthpiece 134 to the heating module 122.

In addition to providing the heating by electrical means, other heating mechanisms are also effective. These include: (a) immersing the heat sink 32 in warm water (see the discussion in connection with FIG. 4 below), (b) heating the mouthpiece 34 by warm water through a hollow construction of an appendix heat sink manually or with a pump, (c) making the heat sink 32 out of a porous ceramic (or plastic) filled with water and heating in a microwave oven, (d) preheating a hermetically sealed mouthpiece 34 with gel 64 in hot water or in a microwave oven and (e) encapsulating an inorganic salt or other material which changes phase from solid to liquid at warm water temperatures 55° C.-70° C. into the heat sink. This phase change process is endothermic and the process is reversed during cooling, as the liquid converts into solid with the release of the heat of fusion. This allows the heat sink to cool down slower and thus mitigate the need for multiple heating steps during the procedure. These options may be less effective than the electrical heating means, because they may require multiple heating charges during the whitening procedure due to the limited thermal retention of each alternate. However, these alternates may be safely used by consumers in their homes, as opposed to use by dental professionals in their offices. The alternative designs of these devices provide the advantages of heat activated teeth whitening without the need for an electrically powered device, of a one hour procedure for whitening all teeth with a single mouthpiece, and no tissue isolation.

An example of an embodiment of the present invention that can be immersed in warm water is shown in FIG. 4. A teeth whitening device 200 includes a heating unit 202 and a mouthpiece 204 attached to the heating unit 202 by a connector 206. The heating unit 202 has an upper portion 210 with an exterior insulating layer 212 and a heat sink 214 attached to the interior of the insulating layer 212. The connector 206 extends through the insulating layer 212 and contacts the heat sink 214, which is made of a thermally conducting material, such as aluminum. A lower portion 220 of the heating unit 202 is removably attached to the upper portion 210 and has an insulating layer 222 and a hollow interior sized and shaped to snugly fit around the heat sink 214. It will be understood that the heat sink 214 can alternately be attached to the interior of the lower portion 220 instead of the upper portion 210.

To heat the heat sink 214 to the desired operating temperature, the lower portion 220 is detached from the upper portion 210 of the heating unit 202, thereby exposing a portion of the heat sink 214. In a separate container (e.g., a pot), water is brought to a boil and the exposed portion of the heat sink 214 is placed into the boiling water. In about ten minutes of such heating, the heat sink 214 reaches a temperature of 80°-90° C. At that point, the heating unit 202 is removed from the water and the lower portion 220 is placed around the heat sink 214 and is attached to the upper portion 210, completely insulating the heat sink 214, so that the heating unit 202 is safe to handle. The balance in heat flow from the heat sink 214 to the mouthpiece 204 is such that the gel temperature does not exceed 41° C.

Depending on the thickness of the insulating layers 212, 222 surrounding the heat sink 214, the teeth whitening device 200 will provide useful thermal activation for up to 20-25 minutes. The heating process must be repeated about three times, with new gel each time, in order to provide an effective treatment. This embodiment provides initial whitening and allows for “touch-up” treatments perhaps two to three times a year.

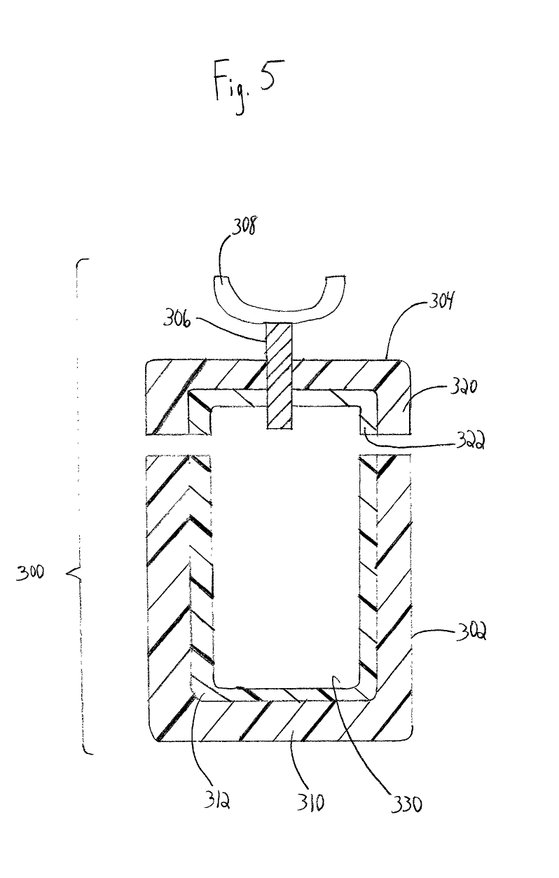

FIG. 5 shows another alternate embodiment of the present invention. A teeth whitening device 300 includes a lower portion 302 and an upper portion 304, which fit together to form a closed container. A connector 306 extends through the upper portion 304 and a mouthpiece 308 is fixed to one end of the connector 306, external to the upper portion 304. The lower portion 302 is formed as a hollow cylinder having an outer insulating layer 310 made of styrofoam or other insulating material and an inner layer 312 made of plastic. The upper portion 304 includes an outer insulating layer 320 made of styrofoam or other insulating material and an inner layer 322 made of plastic. The lower portion 302 and the upper portion 304 relate together such that the respective inner layers 312, 322 form a single chamber 330.

To use the teeth whitening device 300, the upper portion 304 is separated from the lower portion 302, and the lower part of the chamber 330 is filled with a liquid, such as water, water mixed with sodium chloride, sodium acetate, or other microwaveable liquid. The lower portion 302 is placed into a microwave oven to heat the liquid. After the liquid is heated, the lower portion 302 is removed from the microwave oven and the upper portion 304 is attached thereto, thereby sealing the device 300 and completely containing the heated liquid in the chamber 330. Heat from the liquid is transferred to the mouthpiece 308 through the connector 306.

Examples of Performance

The electrically heated/controlled version of the present invention was used by the inventors on eighteen subjects with results ranging in shade change from three to ten. The shade levels and the shade change are based upon measurements taken from the VITAPAN classical guide, produced by Vident of Brea, Calif. The gel contained 20% carbamide peroxide, treatment times varied from 35-60 minutes, and the age of the subjects ranged from 24-68 years. The results of this study are shown in Table 1.

TABLE 1
Effectiveness Data

| | | Treatment | | | |
|---|---|---|---|---|---|
| Sub- | | Time | | | |
| ject | Age | (minutes) | Shade Before | Shade After | Shade Change |
| 1 | 68 | 60 | B4 | B2 | 10 |
| 2 | 37 | 50 | B3 | A1 | 9 |
| 3 | 64 | 50 | B4 | D4 | 5 |
| 4 | 37 | 45 | A2 | <B1 | 3 |
| 5 | 36 | 40 | A2 | B1 | 3 |
| 6 | 40 | 35 | A3 | B2 | 6 |
| 7 | 39 | 60 | D3 | B2 | 7 |
| 8 | 65 | 40 | A35 | C1 | 6 |
| 9 | 58 | 60 | B4 | D4 | 5 |
| 10 | 47 | 55 | A3 | C2 | 5 |
| 11 | 42 | 40 | A3 | A2 | 5 |
| 12 | 49 | 40 | C1 | B2 | 3 |
| 13 | 28 | 40 | A35 | B2/A1 | 9-10 |
| 14 | 42 | 50 | B3 | C1 | 5 |
| 15 | 43 | 50 | D4 | B2 | 5 |
| 16 | 49 | 60 | A35 | B2 | 9 |
| 17 | 55 | 60 | C4 | A35 | 4 |
| 18 | 35 | 40 | C4 | A3 | 7 |

In addition to the tests conducted by the inventors, a similar study was funded by the inventors and conducted by the University of Buffalo School of Dental Medicine. The results of this study involved twenty subjects. Ten were treated with the present invention and a 3% hydrogen peroxide gel; ten were treated solely with the same gel. These results confirmed the effectiveness of the present invention in that under exactly the same conditions in two 30-minute treatments, the present invention produced whiter teeth by 4-5 shades higher than the gel alone. The lower concentration gel (3% hydrogen peroxide) produced up to seven shade changes as compared to ten shade changes with the 20% carbamide peroxide gel.

Trials by the inventors involving the embodiment shown in FIG. 4 yielded similar results. The major difference between the two embodiments being that the heat sink needs to be reheated by boiling water 2-3 times for 20-30 minute treatments in order to achieve equivalent results. In fact, in one case, the take-home unit using 20% carbamide peroxide gel and two 40-minute treatments resulted in a total of 11 shades improvement.

It will be understood that the embodiments described herein are merely exemplary and that a person skilled in the art may make many variations and modifications without departing from the spirit and scope of the present invention. All such variations and modifications are intended to be included within the scope of the invention as defined in the appended claims.

What is claimed is:

1. A teeth whitening system, comprising:
a heating module;
a mouthpiece thermally connected to said heating module such that heat can be transferred from said heating module to said mouthpiece; and
a heat-activated whitening gel positioned in said mouthpiece such that said gel contacts a user's teeth, whereby when heat is transferred from said heating module to said mouthpiece, said gel is activated and whitens the user's teeth.

2. A teeth whitening system according to claim 1, wherein said heating module includes a heat sink and an insulation layer surrounding said heat sink.

3. A teeth whitening system according to claim 2, wherein said mouthpiece includes a metallic connector passing through said insulation layer and contacting said heat sink, thereby creating the thermal connection between said heat sink and said mouthpiece.

4. A teeth whitening system according to claim 3, wherein said heating module is electrically powered and controlled.

5. A teeth whitening system according to claim 4, wherein said connector includes a first thermocouple and said heat sink includes a second thermocouple, whereby said first thermocouple and said second thermocouple act together to regulate the temperature of said mouthpiece.

6. A teeth whitening system according to claim 3, wherein
said insulation layer includes a first portion and a second portion, said first portion and said second portion being releasably connected; and
said heat sink is affixed to said first portion such that when said first portion and said second portion are separated, a portion of said heat sink is exposed, whereby said heat sink can be heated to an operating temperature.

7. A teeth whitening system according to claim 3, wherein said mouthpiece includes
a metallic substructure attached to said connector; and
a molded tooth form surrounding said substructure, said tooth form transferring heat to the user's teeth from said heat sink through said connector and to said metallic substructure, said tooth form preventing the user's teeth from contacting said metallic substructure.

8. A teeth whitening system according to claim 7, wherein said mouthpiece is removably connected to said heating module.

9. A teeth whitening system according to claim 7, wherein said tooth form is sized and shaped to fit at least one of the upper set of teeth and the lower set of teeth of the user.

10. A teeth whitening system according to claim 7, wherein said tooth form is made of plastic.

11. A teeth whitening system according to claim 7, wherein said tooth form is made of molded foam.
